(19) United States
(12) Patent Application Publication
(10) Pub. No.: US 2026/0353247 A1
(43) Pub. Date: Nov. 5, 2026

(54) URSP RULES UPDATE VIA PCF CP PROCEDURE

(71) Applicant: Intel Corporation, Santa Clara, CA (US)

(72) Inventor: Abhijeet Ashok Kolekar, Hillsboro, OR (US)

(21) Appl. No.: 19/117,752

(22) PCT Filed: Oct. 10, 2023
(86) PCT No.: PCT/US2023/034833

§ 371 Date: Apr. 2, 2025

Related U.S. Application Data
(60) Provisional application No. 63/421,905, filed on Nov. 2, 2022.
(60) Provisional application No. 63/422,354, filed on Nov. 3, 2022.

(51) Int. Cl. H04W 40/24; H04W 12/03; H04W 12/041; H04W 12/069

(52) U.S. Cl. CPC H04W 40/24; H04W 12/03; H04W 12/041; H04W 12/069

(57) ABSTRACT

An apparatus and system are described for updating user equipment (UE) Route Selection Policy (URSP) when the UE is in a visited public land mobile network (VPLMN). The policy control function (PCF) of the home PLMN sends a value generated by an authentication server function (AUSF) and counter with updated URSP parameters to a UE. The UE verifies and applies the updated URSP parameters by generating an expected value and determining the expected value matches with the received value. The value is based on the counter, which is associated with a UE-specific key, and either URSP data or an application identification and authentication information.

### PRIORITY CLAIM

This application claims the benefit of priority to U.S. Provisional Patent Application Ser. No. 63/421,905, filed Nov. 2, 2022, and U.S. Provisional Patent Application Ser. No. 63/422,354, filed Nov. 3, 2022, each of which is incorporated herein by reference in its entirety.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such the complexity of such communication systems has increased. As expected, a number of issues abound with the advent of any new technology, including complexities related to various types of transmissions.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a UE Route Selection Policy (URSP) Parameters Update procedure in accordance with some embodiments.

FIG. 4 illustrates prevention of URSP rule misuse by non-genuine application in accordance with some embodiments.

FIG. 5 illustrates data transmission using USRP rules in accordance with some embodiments.

FIG. 6 illustrates providing integrity and URSP information in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

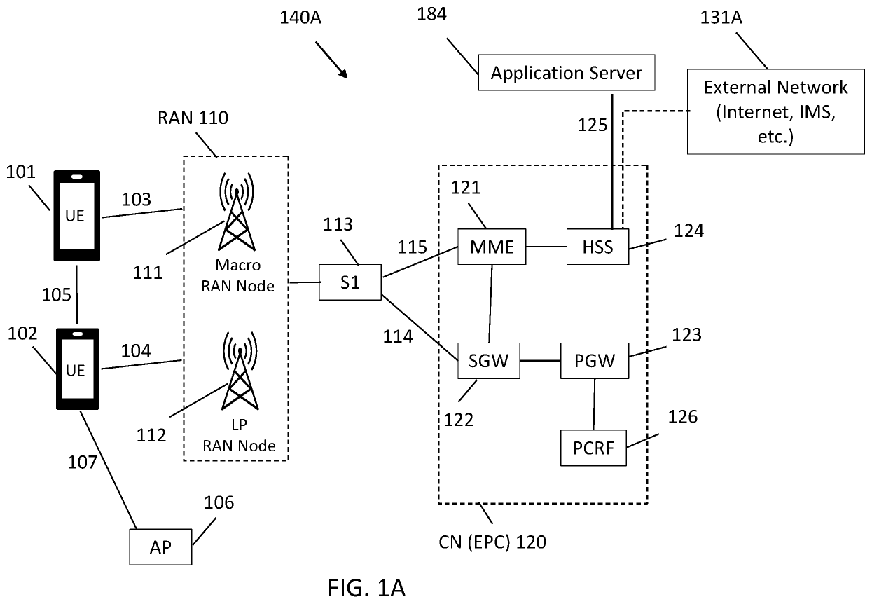

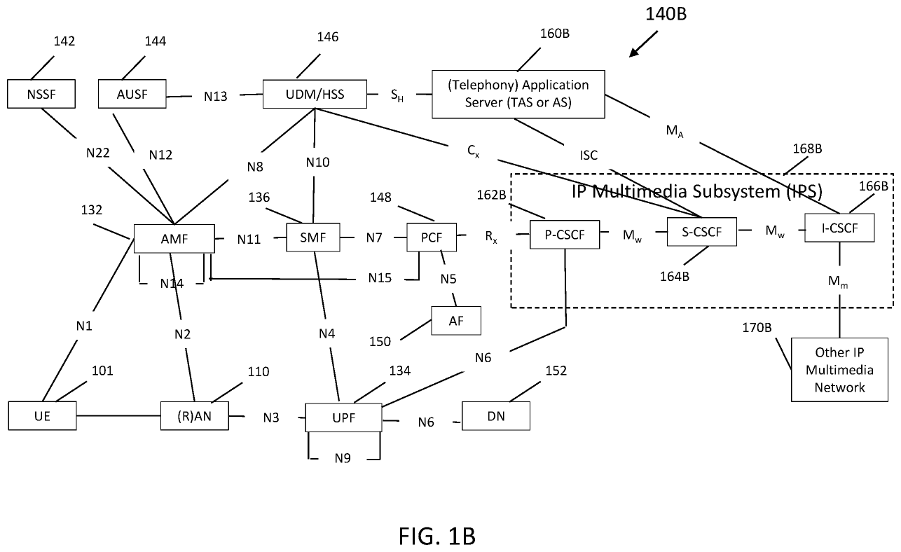

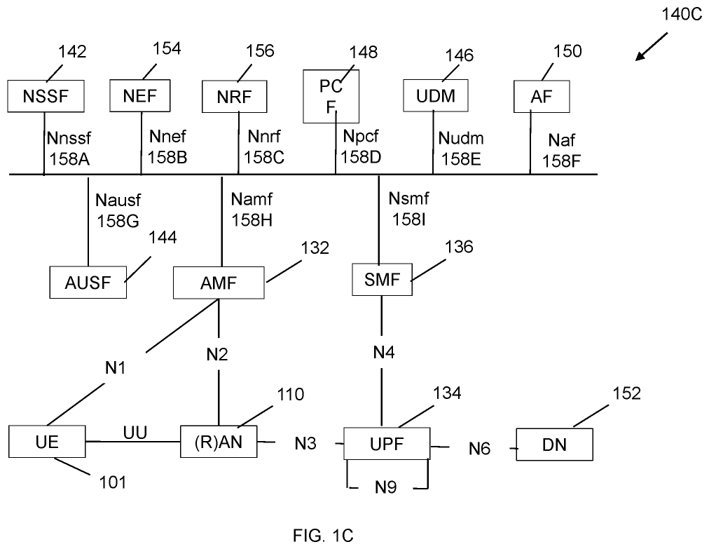

FIG. 1A illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

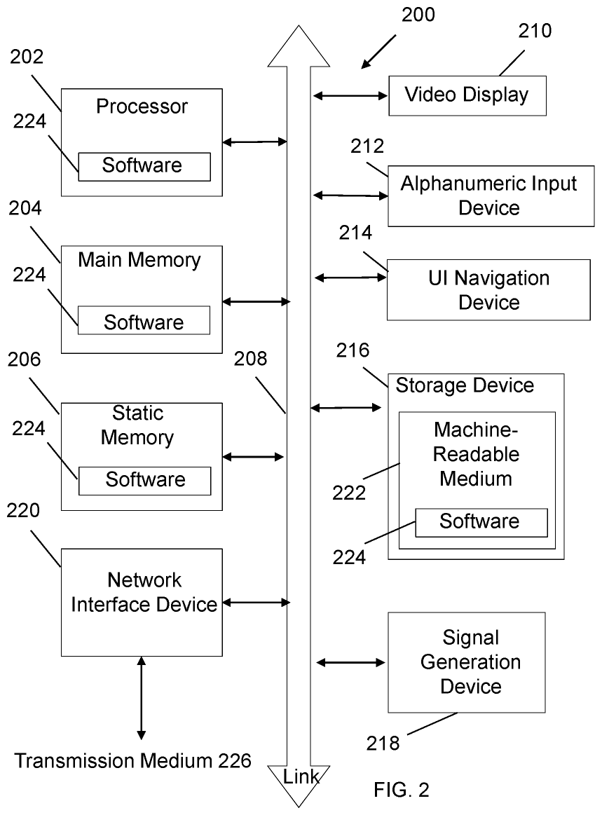

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHZ), ITS-G5B (i.e., Operation in European ITS frequency bands dedicated to ITS non-safety applications in the frequency range 5,855 GHz to 5,875 GHZ), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHz, 37-38.6 GHZ, 38.6-40 GHz, 42-42.5 GHZ, 57-64 GHZ, 71-76 GHz, 81-86 GHz and 92-94 GHz, etc.), the ITS (Intelligent Transport Systems) band of 5.9 GHz (typically 5.85-5.925 GHZ) and 63-64 GHz, bands currently allocated to WiGig such as WiGig Band 1 (57.24-59.40 GHZ), WiGig Band 2 (59.40-61.56 GHz) and WiGig Band 3 (61.56-63.72 GHz) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHZ, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, a service or application may be able to select among multiple packet data unit (PDU) sessions on a network slice. URSP is provided by the PCF, via the AMF, to the UE and indicates which PDU session is to be selected for that service or application. URSP allows dynamic configuration of the slice selection policy.

The PCF provides the URSP rule to the UE for a specific operator application. The URSP rule includes the application ID and the operator desired action that the UE should apply for this application, e.g. mapping of traffic to a specific slice. The UE matches the data sent by an application to a specific URSP rule based on the application ID used by the application in the UE and the corresponding application ID in the URSP rule. Both the PCF and the UE are trust model actors, thus it may be desirable to improve protection of the URSP rules provisioning in roaming scenarios (e.g., based on trust relationships between the home public land mobile network (HPLMN) and visited PLMN (VPLMN)) as well as enhance the security/integrity protection of URSP rules when provided from HPLMN and/or VPLMN. Currently, the UE is allowed to accept rules from the HPLNM as defined in TS 23.503, implying that the VPLNM cannot change the rules in transit. With the current protocol, methods enabling the UE to verify the authenticity of the rules do not exist, which forces the UE to trust the VPLNM.

The URSP rules update may be provided via PCF Control Plane Procedure security mechanism. Accordingly, the security functions are described to update the URSP parameters using the PCF control plane procedure are described. The security functions are described in the context of the functions supporting the delivery of URSP Parameters Update Data from the PCF to the UE after the UE has successfully registered to the 5G network. If the PCF supports the control plane procedure for URSP Parameters Update, the AUSF stores the K_{AUSF} after completing primary authentication. The AUSF manages the UE authentication using the Subscription Concealed Identifier (SUCI) or the Subscription Permanent Identifier (SUPI) and to manage the root session key K_{AUSF}; further keys are derived from the root session key K_{AUSF}.

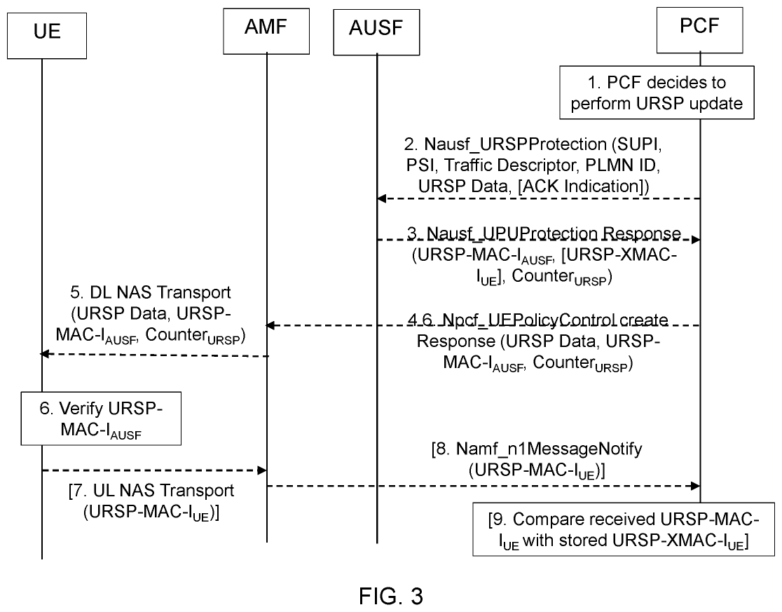

The PCF may decide to perform URSP Parameters Update anytime after the UE has been successfully authenticated and registered to the 5G system. FIG. 3 illustrates a URSP Parameters Update procedure in accordance with some embodiments. Several options may be used for URSP delivery using the VPLMN, and may be used in various scenarios including: the home PCF (H-PCF) provides VPLMN-specific URSP Rules to the UE or the H-PCF generates VPLMN-specific URSP rules by taking service parameters from the V-PCF or the V-AF into account. In this latter case, the V-PCF sends a Npcf_UEPolicyControl message to create a request to the H-PCF, and the rest of the procedures work as per below. In this option, at operation 8 if a transparent container with the URSP-MAC-I_{UE} was received in the UL non-access stratum (NAS) transport message, the AMF sends a Namf_N1MessageNotify request message with the transparent container to the V-PCF. The VPCF forwards the reply to the H-PCF in a Npcf_UEPolicyControl Update Request or an equivalent message.

At operation 1 in FIG. 3, the PCF decides to perform the URSP Parameters Update using the control plane procedure while the UE is registered to the 5G system. If the final consumer of any of the URSP parameters to be updated is the Universal Subscriber Identity Module (USIM), the PCF protects these parameters using a secured packet mechanism (see 3GPP TS 31.115) to update the parameters stored on the USIM. The PCF then prepares the URSP Parameters Update Data (URSP Data) by including the parameters protected by the secured packet, if any, and any URSP parameters for which the final consumer is the mobile equipment (ME) (the UE includes the ME and the USIM).

At operations 2 and 3, the PCF invokes a Nausf_URSPProtection service operation message by including the URSP Data to the AUSF to get URSP-MAC-I_{AUSF} and Counter_{URSP}. If the PCF decides that the UE is to acknowledge the successful security check of the received URSP Parameters Update Data, the PCF sets the corresponding indication in the URSP Parameters Update Data and include the ACK Indication in the Nausf_URSPProtection service operation message to signal that the URSP-XMAC-I_{UE} is expected.

Including URSP Parameters Update Data in the calculation of URSP-MAC-I_{AUSF} allows the UE to verify that it has not been tampered with by any intermediary VPLMN/V-PCF. The expected URSP-XMAC-I_{UE} allows the PCF to verify that the UE correctly received the URSP Parameters Update Data.

At operation 4, the PCF invokes a Npcf_UEPolicyControl create response service operation (as a response to Npcf_UEPolicyControl create request). The Npcf_UEPolicyControl create response message contains the URSP Parameters Update Data, URSP-MAC-I_{AUSF}, Counter_{URSP} within the Access and Mobility Subscription data. If the PCF requests an acknowledgement, the PCF temporarily stores the expected URSP-XMAC-I_{UE}.

At operation 5, upon receiving the Npcf_UEPolicyControl create response message, the AMF sends a DL NAS transport message to the served UE. The AMF includes the transparent container received from the PCF in the DL NAS Transport message. Note that the PCF may send the Npcf_UEPolicyControl create response message to the home AMF, which then sends the DL NAS transport message to the visited AMF (i.e., serving AMF).

At operation 6, on receiving the DL NAS transport message, the UE calculates the URSP-MAC-I_{AUSF} in the same way as the AUSF on the received URSP Parameters Update Data and the Counter_{URSP} and verifies whether it matches the URSP-MAC-I_{AUSF} value received in the DL NAS transport message. If the verification of URSP-MAC-I_{AUSF} is successful and the URSP Data contains any parameters protected by a secured packet, the ME forwards the secured packet to the USIM. If the verification of URSP-MAC-I_{AUSF} is successful and the URSP Data contains any URSP rule that is not protected by a secure packet, the ME updates its stored URSP rules with the received parameters in PCF URSP Data.

At operation 7, if the PCF has requested an acknowledgment from the UE and the UE has successfully verified and updated the URSP Parameters Update Data provided by the PCF, then the UE sends the UL NAS transport message to the serving AMF. The UE generates the URSP-MAC-I_{UE} and includes the generated URSP-MAC-I_{UE} in a transparent container in the UL NAS Transport message.

At operation 8, if a transparent container with the URSP-MAC-I_{UE} was received in the UL NAS transport message, the AMF sends a Namf_N1MessageNotify request message with the transparent container to the PCF.

At operation 9, if the PCF indicated that the UE is to acknowledge the successful security check of the received URSP Parameters Update Data, then the PCF compares the received URSP-MAC-I_{UE} with the expected URSP-XMAC-I_{UE} that the PCF stored temporarily in operation 4.

### URSP Parameters Update Counter

The AUSF and the UE associate a 16-bit counter, Counter_{URSP}, with the key K_{AUSF}. The UE initializes the Counter_{URSP} to 0x00 0x00 when the K_{AUSF} is derived. To generate the URSP-MAC-I_{AUSF}, the AUSF uses a counter called a Counter_{URSP}. The AUSF increments the Counter_{URSP} for every new computation of the URSP-MAC-I_{AUSF}. The Counter_{URSP} is used as freshness input into URSP-MAC-I_{AUSF} and URSP-MAC-I_{UE} derivations to mitigate a replay attack. The AUSF sends the value of the Counter_{URSP} (used to generate the URSP-MAC-I_{AUSF}) along with the URSP-MAC-I_{AUSF} to the UE. The UE only accepts a Counter_{URSP} value greater than the stored Counter_{URSP} value. The UE updates the stored Counter_{URSP} with the received Counter_{URSP} only if verifying the received URSP-MAC-I_{AUSF} is successful. The UE uses the Counter_{URSP} received from the PCF when deriving the URSP-MAC-I_{UE} for the UE Parameters Update Data acknowledgment.

The AUSF and the UE maintains the Counter_{URSP} for the lifetime of the K_{AUSF}. The AUSF, which supports the URSP Parameters Update using the control plane procedure, initializes the Counter_{URSP} to 0x00 0x01 when the K_{AUSF} is derived. The AUSF sets the Counter_{URSP} to 0x00 0x02 after the first calculated URSP-MAC-I_{AUSF} and monotonically increments the Counter_{URSP} for each additional calculated URSP-MAC-I_{AUSF}. The URSP Counter value of 0x00 0x00 is not used to calculate the URSP-MAC-I_{AUSF} and URSP-MAC-I_{UE}.

The AUSF suspends the URSP Parameters Update protection service for the UE if the Counter_{URSP} associated with the K_{AUSF} of the UE is about to wrap around. When a fresh K_{AUSF} is generated for the UE, the Counter_{URSP} at the AUSF is reset to 0x00 0x01 as defined above, and the AUSF resumes the URSP Parameters Update protection service for the UE.

### Nausf_URSPProtection Service

The following table illustrates AUSF's security-related services for URSP Parameters Update.

TABLE 1
NF services for URSP Parameters Update provided by AUSF

| | Service | Operation | Example |
|---|---|---|---|
| Service Name | Operations | Semantics | Consumer(s) |
| Nausf_URSPProtection | Protect | Request/Response | PCF |

Service operation name: Nausf_URSPProtection.

Description: The AUSF calculates the URSP-MAC-I_{AUSF} using a UE-specific home key (K_{AUSF}) along with the URSP Parameters Update Data received from the requester network function (NF) and delivers the URSP-MAC-I_{AUSF} and Counter_{URSP} to the requester NF. If the ACK Indication input is present, then the AUSF computes the URSP-XMAC-I_{UE} and returns the computed URSP-XMAC-I_{UE} in the response. The URSP Parameters Update Data details are specified in TS 24.50.

Input, Required: Requester ID, SUPI, service name, URSP Parameters Update Data.

Input, Optional: ACK Indication.

Output, Required: URSP-MAC-I_{AUSF}, Counter_{URSP} or error (counter_wrap).

Output, Optional: URSP-XMAC-I_{UE} (if the ACK Indication input is present, then the URSP-XMAC-I_{UE} is computed and returned).

URSP-MAC-I_{AUSF} generation function

When deriving a URSP-MAC-I_{AUSF} from K_{AUSF}, the following parameters are used to form the input S to the KDF.

FC=0x7C,

P0=PSI+URSP Parameters Update Data,

L0=length of URSP Parameters Update Data

P1=Counter_{URSP}

L1=length of Counter_{URSP}

The input key is K_{AUSF}.

The URSP-MAC-I_{AUSF} is identified with the 128 least significant bits of the output of the KDF.

URSP-MAC-I_{UE} generation function

When deriving a URSP-MAC-I_{UE} from K_{AUSF}, the following parameters are used to form the input S to the KDF.

FC=0x7C,

P0=0x01 (URSP Acknowledgement: Verified the URSP Parameters Update Data successfully),

L0=length of URSP Acknowledgement (i.e. 0x00 0x01)

P1=Counter_{URSP}

L1=length of Counter_{URSP}

The input key is K_{AUSF}.

The URSP-MAC-I_{UE} is identified with the 128 least significant bits of the output of the KDF.

In addition, URSP rule misuse by a non-genuine application may be an issue. As above, operators can use the URSP rules to configure UEs to steer the traffic of specific applications based on operators' policy. However, the application identity is not a secure identifier and can be misused: the user may download another application (not the application created by the operator), which presents the same application identity.

The trust model actors include the PCF and the UE. As above, the PCF provides, for a specific operator application, the URSP rule to the UE. The URSP rule includes the application ID and the operator desired action, which the UE should apply for this application, e.g. mapping of traffic to a specific slice. The UE matches the data sent by an application to a specific URSP rule based on the application ID used by the application in the UE and the corresponding application ID in the URSP rule. The subscriber may have an interest and ability to reuse operator-privileged network resources, e.g. a specific network slice, with another application by reusing the same application ID of the genuine application of the operator. The user can sideload applications in a UE (e.g., transferred directly via USB or Bluetooth), or they can be downloaded from a non-official application store.

For an attack model, the user can install applications on the UE that do not originate from official application stores, i.e. sideloaded e.g. via USB cable or Bluetooth or from a non-official application store. The non-genuine application installed on the UE reuses the application ID from a genuine operator application with privileged network access. The application ID of the genuine operator application is part of a URSP rule in the UE, including the corresponding action the UE is to apply for the data of that application. The UE then maps the data from the non-genuine application according to the URSP rule, since the application ID from the non-genuine application matches the application ID from the URSP rule.

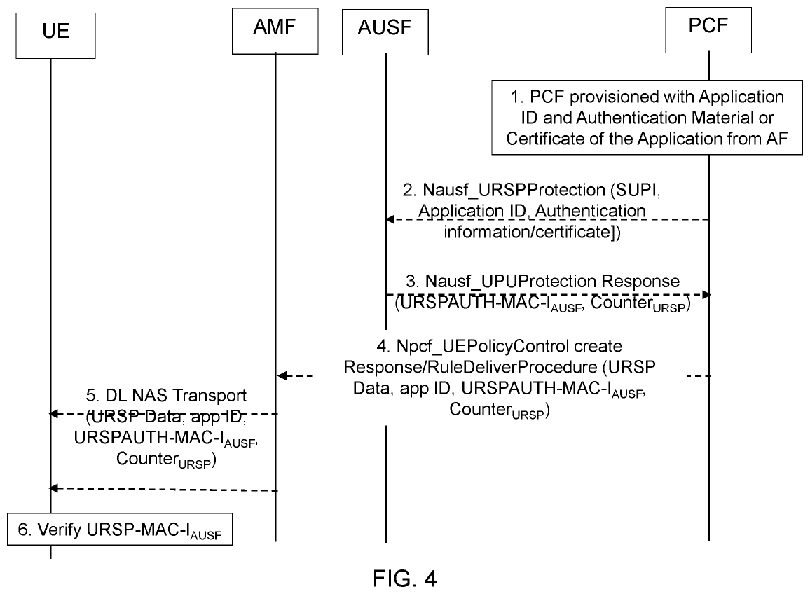

The PCF may decide to a perform URSP Parameters Update anytime after the UE has been successfully authenticated and registered to the 5G system. The security procedure for the URSP rule delivery procedure is described in FIG. 4, which illustrates prevention of URSP rule misuse by non-genuine application in accordance with some embodiments.

As shown, at operation 1, the PCF is provisioned with the application ID and the authentication information or token or certificate of the genuine publisher from an AF. The PCF decides to perform the URSP Parameters Update. Static authentication information may include the application's certificate or token shared between the application client and server or any other application-specific information.

At operations 2 and 3, the PCF invokes a Nausf_URSPProtection service operation message by including the authentication information or token or certificate to the AUSF to get URSPAUTH-MAC-I_{AUSF} and Counter_{URSP}.

At operations 4 and 5, the PCF uses existing methods for a URSP delivery procedure, which contains URSP Parameters Update Data, app ID, URSPAUTH-MAC-I_{AUSF}, and Counter_{URSP}.

At operation 6, if the installed application in the UE wants to send data, the UE calculates the URSPAUTH-MAC-I_{AUSF} in the same way as the AUSF with the app ID and other authentication material or token or certificate. If the match is successful, the UE applies the URSP rule accordingly.

As above, if the PCF has requested an acknowledgment from the UE and the UE has successfully verified and updated the URSP Parameters Update Data provided by the PCF, operations 7-9 of FIG. 3 may be duplicated in FIG. 4.

### URSPAUTH-MAC-I_{AUSF} Generation Function

When deriving a URSPAUTH-MAC-I_{AUSF} from K_{AUSF}, the following parameters are used to form the input S to the KDF.

FC=0xPP,

P0=Application ID+Authentication Information,

L0=length of Application ID+Authentication Information

P1=Counter_{URSP}

L1=length of Counter_{URSP}

Key used: K_{AUSF}.

Output: 128 least significant bits of the output of the KDF.

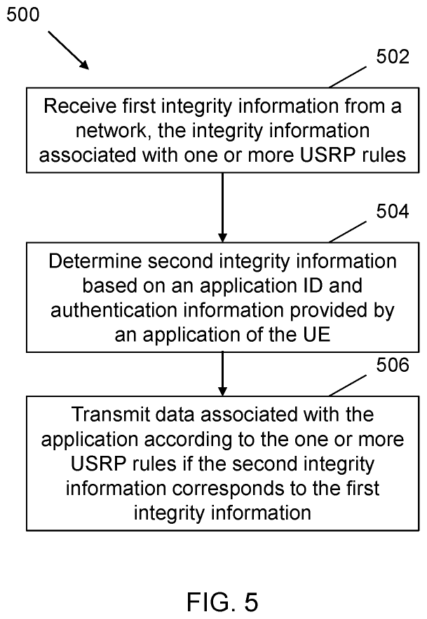

In some embodiments, the electronic device(s), network(s), system(s), chip(s) or component(s), or portions or implementations thereof, of FIGS. 1-4, or some other figure herein, may be configured to perform one or more processes, techniques, or methods as described herein, or portions thereof. One such process is depicted in FIG. 5, which illustrates data transmission using USRP rules. The process of FIG. 5 may be performed by a UE or a portion thereof. For example, the process may include, at operation 502, receiving first integrity information from a network, the integrity information associated with one or more USRP rules. At operation 504, the process may further include determining second integrity information based on an application id and authentication information provided by an application of the UE. At operation 506, the process may further include transmitting data associated with the application according to the one or more USRP rules if the second integrity information corresponds to the first integrity information. The integrity information may include, for example, a URSPAUTH-MAC-I_{AUSF} and/or information used to derive the URSPAUTH-MAC-I_{AUSF}.

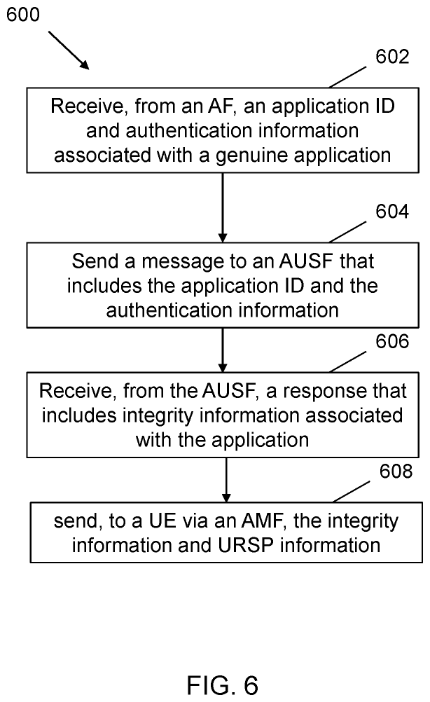

FIG. 6 illustrates providing integrity and URSP information. In some embodiments, the process of FIG. 6 may be performed by a PCF or a portion thereof. At operation 602, the process may include receiving, from an AF, an application ID and authentication information associated with a genuine application. At operation 604, the process may further include sending a message to an AUSF that includes the application ID and the authentication information. At operation 606, the process may further include receiving, from the AUSF, a response that includes integrity information associated with the application. At operation 608, the process may further include sending, to a UE via an AMF, the integrity information and URSP information.

In the embodiments shown in FIGS. 1-6, the URSP rules may contain policy information for one or more of: Access Network Discovery & Selection, UE Route Selection, vehicle-to-everything (V2X), ProSe, Ranging/Sidelink Positioning, and Aircraft-to-Everything (A2X), among others.

Example 1 is an apparatus of a policy control function (PCF), the apparatus comprising: processing circuitry to configure the PCF to: determine that user equipment (UE) Route Selection Policy (URSP) parameters for a UE are to be updated while the UE is registered to a visited public land mobile network (VPLMN); transmit, to an authentication server function (AUSF), a Nausf_URSPProtection service operation message that includes, URSP Data, the URSP Data including the URSP parameters; receive, from the AUSF, a URSP-MAC-IAUSF and CounterURSP for the UE to verify the URSP Data; and transmit, to the UE via an access and mobility function (AMF), a Npcf_UEPolicyControl create response message that contains the URSP Data, URSP-MAC-IAUSF, and CounterURSP; and memory configured to store the URSP Data.

In Example 2, the subject matter of Example 1 includes, wherein: the processing circuitry further configures the PCF to: determine that a final consumer of the URSP parameters is a Universal Subscriber Identity Module (USIM) of the UE; and in response to a determination that the final consumer of the URSP parameters to be updated is the USIM of the UE, protect the URSP parameters using a secured packet, and the URSP Data includes the secured packet.

In Example 3, the subject matter of Examples 1-2 includes, wherein the processing circuitry further configures the PCF to: determine that the UE is to acknowledge a successful security check of the URSP Data, the successful security check indicating that the URSP Data has not been tampered with by an intermediary VPLMN or V-PCF; and provide an acknowledgment (ACK) Indication in the Nausf_URSPProtection service operation message to signal that a URSP-XMAC-IUE is to be sent from the UE to the PCF in response to the successful security check.

In Example 4, the subject matter of Example 3 includes, wherein the processing circuitry further configures the PCF to: in response to transmission of the Npcf_UEPolicyControl create response message, receive a Namf_N1MessageNotify request message from the AMF, the Namf_N1MessageNotify request message including a transparent container that contains a URSP-MAC-IUE generated by the UE; and compare the URSP-MAC-IUE with an expected URSP-XMAC-IUE stored in the PCF.

In Example 5, the subject matter of Example 4 includes, wherein the processing circuitry further configures the PCF to in response to transmission of the Nausf_URSPProtection service operation message, receive a Nausf_URSPProtection service operation response containing the expected URSP-XMAC-IUE, which is generated by the AUSF.

In Example 6, the subject matter of Examples 1-5 includes, wherein the CounterURSP is initialized when a UE-specific home key (KAUSF) is derived and the URSP-MAC-IAUSF is generated using KAUSF, which is incremented for each new URSP-MAC-IAUSF computation and is derived from KAUSF.

In Example 7, the subject matter of Examples 1-6 includes, wherein: the PCF is a home PCF (H-PCF), and the processing circuitry further configures the H-PCF to provide VPLMN-specific URSP rules to the UE prior to the UE being registered to the VPLMN.

In Example 8, the subject matter of Examples 1-7 includes, wherein: the PCF is a home PCF (H-PCF), and the processing circuitry further configures the H-PCF to generate VPLMN-specific URSP rules by taking service parameters from a visited PCF (V-PCF) or visited application function (V-AF) into account after reception of a Npcf_UEPolicyControl message to create a request from the V-PCF.

In Example 9, the subject matter of Example 8 includes, wherein the processing circuitry further configures the H-PCF to receive, from the V-PCF via the AMF, a Npcf_UEPolicyControl Update Request including a transparent container that contains a URSP-MAC-IUE.

In Example 10, the subject matter of Examples 1-9 includes, wherein the PCF is provisioned with an application identifier (app ID) of an application, and at least one of authentication information, token, or certificate of a genuine publisher of the application from an application function.

In Example 11, the subject matter of Example 10 includes, wherein: the processing circuitry further configures the PCF to: transmit, to the AUSF, another Nausf_URSPProtection service operation message that includes the app ID and the at least one of authentication information, token, or certificate; receive, from the AUSF in response to the other Nausf_URSPProtection service operation message, a Nausf_URSPProtection response that includes a URSPAUTH-MAC-IAUSF and CounterURSP; and transmit, to the UE via the AMF, another Npcf_UEPolicyControl create response message that contains the URSP Data, app ID, URSP-MAC-IAUSF, and CounterURSP, the other Npcf_UEPolicyControl create response message to configure the UE to apply the URSP data in response to verification by the UE of a URSPAUTH-MAC-IAUSF generated by the UE based on the app ID with the URSPAUTH-MAC-IAUSF in the other Npcf_UEPolicyControl create response message.

In Example 12, the subject matter of Example 11 includes, wherein the URSPAUTH-MAC-IAUSF is generated using a UE-specific home key (KAUSF) and the CounterURSP.

Example 13 is an apparatus of a user equipment (UE), the apparatus comprising: processing circuitry to configure the UE to: receive, while the UE is registered to a visited public land mobile network (VPLMN), a downlink (DL) non-access stratum (NAS) transport message from an access and mobility function (AMF), the DL NAS transport message containing a transparent container that includes, URSP Data, a URSP-MAC-IAUSF, and a CounterURSP from a home policy control function (H-PCF), the URSP Data containing updated UE Route Selection Policy (URSP) parameters; calculate an expected URSP-MAC-IAUSF based on the CounterURSP; verify the URSP

Data in response to a determination that the expected URSP-MAC-IAUSF matches the URSP-MAC-IAUSF; and apply the updated URSP parameters in response to a successful verification of the URSP Data; and memory configured to store the URSP Data.

In Example 14, the subject matter of Example 13 includes, wherein: a final consumer of the URSP parameters is a Universal Subscriber Identity Module (USIM) of the UE, and the URSP Data includes a secured packet that protects the URSP parameters in response to the final consumer of the URSP parameters being the USIM of the UE.

In Example 15, the subject matter of Examples 13-14 includes, wherein the processing circuitry further configures the UE to: determine that the updated URSP parameters include an acknowledgment (ACK) indication that the UE is to acknowledge the successful verification, and in response to a determination that the updated URSP parameters include the ACK indication, transmit, to the H-PCF via the AMF after the successful verification, an uplink (UL) NAS transport message containing a transparent container that includes the expected URSP-MAC-IAUSF.

In Example 16, the subject matter of Examples 13-15 includes, wherein the processing circuitry further configures the UE to: associate the CounterURSP with a UE-specific home key (KAUSF); determine whether the CounterURSP is greater than a stored CounterURSP; generate the expected URSP-MAC-IAUSF using the CounterURSP in response to a determination that the CounterURSP is greater than the stored CounterURSP; update the stored CounterURSP with the CounterURSP in response to the determination that the expected URSP-MAC-IAUSF matches the URSP-MAC-IAUSF; and maintain the stored CounterURSP for lifetime of the KAUSF.

In Example 17, the subject matter of Examples 13-16 includes, wherein the processing circuitry further configures the UE to: receive, from the AMF, another DL NAS transport message, the DL NAS transport message containing a transparent container that includes other URSP Data that contains other updated URSP parameters, a URSPAUTH-MAC-IAUSF, and another CounterURSP; generate an expected URSPAUTH-MAC-IAUSF based on an application identifier (app ID) of an application, at least one of authentication information, token, or certificate of a genuine publisher of the application from an application function, and the other CounterURSP; verify the other URSP Data in response to a determination that the expected URSPAUTH-MAC-IAUSF matches the URSPAUTH-MAC-IAUSF; and apply the other updated URSP parameters in response to a successful verification of the other URSP Data.

In Example 18, the subject matter of Example 17 includes, wherein the processing circuitry further configures the UE to: associate the other CounterURSP with a UE-specific home key (KAUSF); determine whether the other CounterURSP is greater than a stored other CounterURSP; generate the expected URSPAUTH-MAC-IAUSF using the other CounterURSP in response to a determination that the other CounterURSP is greater than the stored other CounterURSP; update the stored other CounterURSP with the other CounterURSP in response to the determination that the expected URSPAUTH-MAC-IAUSF matches the URSP-MAC-IAUSF; and maintain the stored other CounterURSP for lifetime of the KAUSF.

Example 19 is a non-transitory computer-readable storage medium that stores instructions for execution by one or more processors of a policy control function (PCF), the one or more processors to configure the PCF to, when the instructions are executed: determine that user equipment (UE) Route Selection Policy (URSP) parameters for a UE are to be updated while the UE is registered to a visited public land mobile network (VPLMN); transmit, to an authentication server function (AUSF), a Nausf_URSPProtection service operation message that includes, URSP Data, the URSP Data including the URSP parameters in a secured packet; receive, from the AUSF, a URSP-MAC-IAUSF and CounterURSP for the UE to verify the URSP Data; and transmit, to the UE via an access and mobility function (AMF), a Npcf_UEPolicyControl create response message that contains the URSP Data, URSP-MAC-IAUSF, and CounterURSP.

In Example 20, the subject matter of Example 19 includes, wherein the one or more processors, when the instructions are executed, configure the PCF to: transmit, to the AUSF, another Nausf_URSPProtection service operation message that includes an application identifier (app ID) of an application, and at least one of authentication information, token, or certificate of a genuine publisher of the application from an application function; receive, from the AUSF in response to the other Nausf_URSPProtection service operation message, a Nausf_URSPProtection response that includes a URSPAUTH-MAC-IAUSF and CounterURSP; and transmit, to the UE via the AMF, another Npcf_UEPolicyControl create response message that contains the URSP Data, app ID, URSP-MAC-IAUSF, and CounterURSP, the other Npcf_UEPolicyControl create response message to configure the UE to apply the URSP data in response to verification by the UE of a URSPAUTH-MAC-IAUSF generated by the UE based on the app ID with the URSPAUTH-MAC-IAUSF in the other Npcf_UEPolicyControl create response message.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. An apparatus of a user equipment (UE), the apparatus comprising:
processing circuitry to configure the UE to:
receive, while the UE is registered to a visited public land mobile network (VPLMN), a downlink (DL) non-access stratum (NAS) transport message from an access and mobility function (AMF), the DL NAS transport message containing a transparent container that includes URSP Data, a URSP-MAC-I_{AUSF}, and a Counter_{URSP} from a home policy control function (H-PCF), the URSP Data containing updated UE Route Selection Policy (URSP) parameters;
calculate an expected URSP-MAC-I_{AUSF} based on the Counter_{URSP};
verify the URSP Data in response to a determination that the expected URSP-MAC-I_{AUSF} matches the URSP-MAC-I_{AUSF}; and
apply the updated URSP parameters in response to a successful verification of the URSP Data; and
memory configured to store the URSP Data.

2. The apparatus of claim 1, wherein:
a final consumer of the updated URSP parameters is a Universal Subscriber Identity Module (USIM) of the UE, and
the URSP Data includes a secured packet that protects the updated URSP parameters in response to the final consumer of the updated URSP parameters being the USIM of the UE.

3. The apparatus of claim 1, wherein the processing circuitry further configures the UE to:
determine that the updated URSP parameters include an acknowledgment (ACK) indication that the UE is to acknowledge the successful verification, and
in response to a determination that the updated URSP parameters include the ACK indication, transmit, to the H-PCF via the AMF after the successful verification, an uplink (UL) NAS transport message containing a transparent container that includes the expected URSP-MAC-I_{AUSF}.

4. The apparatus of claim 1, wherein the processing circuitry further configures the UE to:
associate the Counter_{URSP} with a UE-specific home key (K_{AUSF});
determine whether the Counter_{URSP} is greater than a stored Counter_{URSP};
generate the expected URSP-MAC-I_{AUSF} using the Counter_{URSP} in response to a determination that the Counter_{URSP} is greater than the stored Counter_{URSP};
update the stored Counter_{URSP} with the Counter_{URSP} in response to the determination that the expected URSP-MAC-I_{AUSF} matches the URSP-MAC-I_{AUSF}; and
maintain the stored Counter_{URSP} for lifetime of the K_{AUSF}.

5. The apparatus of claim 1, wherein the processing circuitry further configures the UE to:
receive, from the AMF, another DL NAS transport message, the DL NAS transport message containing a transparent container that includes other URSP Data that contains other updated URSP parameters, a URSPAUTH-MAC-I_{AUSF}, and another Counter_{URSP};
generate an expected URSPAUTH-MAC-I_{AUSF} based on an application identifier (app ID) of an application, at least one of authentication information, token, or certificate of a genuine publisher of the application from an application function, and the other Counter_{URSP};
verify the other URSP Data in response to a determination that the expected URSPAUTH-MAC-I_{AUSF} matches the URSPAUTH-MAC-I_{AUSF}; and
apply the other updated URSP parameters in response to a successful verification of the other URSP Data.

6. The apparatus of claim 5, wherein the processing circuitry further configures the UE to:
associate the other Counter_{URSP} with a UE-specific home key (K_{AUSF});
determine whether the other Counter_{URSP} is greater than a stored other Counter_{URSP};
generate the expected URSPAUTH-MAC-I_{AUSF} using the other Counter_{URSP} in response to a determination that the other Counter_{URSP} is greater than the stored other Counter_{URSP};
update the stored other Counter_{URSP} with the other Counter_{URSP} in response to the determination that the expected URSPAUTH-MAC-I_{AUSF} matches the URSP-MAC-I_{AUSF}; and
maintain the stored other Counter_{URSP} for lifetime of the K_{AUSF}.

7. An apparatus of a policy control function (PCF), the apparatus comprising:
processing circuitry to configure the PCF to:
determine that user equipment (UE) Route Selection Policy (URSP) parameters for a UE are to be updated while the UE is registered to a visited public land mobile network (VPLMN);
transmit, to an authentication server function (AUSF), a Nausf_URSPProtection service operation message that includes URSP Data, the URSP Data including the URSP parameters;
receive, from the AUSF, a URSP-MAC-I_{AUSF} and Counter_{URSP} for the UE to verify the URSP Data; and
transmit, to the UE via an access and mobility function (AMF), a Npcf_UEPolicyControl create response message that contains the URSP Data, URSP-MAC-I_{AUSF}, and Counter_{URSP}; and memory configured to store the URSP Data.

8. The apparatus of claim 7, wherein:
the processing circuitry further configures the PCF to:
determine that a final consumer of the URSP parameters is a Universal Subscriber Identity Module (USIM) of the UE; and
in response to a determination that the final consumer of the URSP parameters to be updated is the USIM of the UE, protect the URSP parameters using a secured packet, and the URSP Data includes the secured packet.

9. The apparatus of claim 7, wherein the processing circuitry further configures the PCF to:
determine that the UE is to acknowledge a successful security check of the URSP Data, the successful security check indicating that the URSP Data has not been tampered with by an intermediary VPLMN or V-PCF; and
provide an acknowledgment (ACK) Indication in the Nausf_URSPProtection service operation message to signal that a URSP-XMAC-I_{UE} is to be sent from the UE to the PCF in response to the successful security check.

10. The apparatus of claim 9, wherein the processing circuitry further configures the PCF to:
in response to transmission of the Npcf_UEPolicyControl create response message, receive a Namf_N1MessageNotify request message from the AMF, the Namf_N1MessageNotify request message including a transparent container that contains a URSP-MAC-I_{UE} generated by the UE; and
compare the URSP-MAC-I_{UE} with an expected URSP-XMAC-I_{UE} stored in the PCF.

11. The apparatus of claim 10, wherein the processing circuitry further configures the PCF to in response to transmission of the Nausf_URSPProtection service operation message, receive a Nausf_URSPProtection service operation response containing the expected URSP-XMAC-I_{UE}, which is generated by the AUSF.

12. The apparatus of claim 7, wherein the Counter_{URSP} is initialized when a UE-specific home key (K_{AUSF}) is derived and the URSP-MAC-I_{AUSF} is generated using K_{AUSF}, which is incremented for each new URSP-MAC-I_{AUSF} computation and is derived from K_{AUSF}.

13. The apparatus of claim 7, wherein:
the PCF is a home PCF (H-PCF), and
the processing circuitry further configures the H-PCF to provide VPLMN-specific URSP rules to the UE prior to the UE being registered to the VPLMN.

14. The apparatus of claim 7, wherein:
the PCF is a home PCF (H-PCF), and
the processing circuitry further configures the H-PCF to generate VPLMN-specific URSP rules by taking service parameters from a visited PCF (V-PCF) or visited application function (V-AF) into account after reception of a Npcf_UEPolicyControl message to create a request from the V-PCF.

15. The apparatus of claim 14, wherein the processing circuitry further configures the H-PCF to receive, from the V-PCF via the AMF, a Npcf_UEPolicyControl Update Request including a transparent container that contains a URSP-MAC-I_{UE}.

16. The apparatus of claim 7, wherein the PCF is provisioned with an application identifier (app ID) of an application, and at least one of authentication information, token, or certificate of a genuine publisher of the application from an application function.

17. The apparatus of claim 16, wherein:
the processing circuitry further configures the PCF to:
transmit, to the AUSF, another Nausf_URSPProtection service operation message that includes the app ID and the at least one of authentication information, token, or certificate; receive, from the AUSF in response to the other Nausf_URSPProtection service operation message, a Nausf_URSPProtection response that includes a URSPAUTH-MAC-I_{AUSF} and Counter_{URSP}; and
transmit, to the UE via the AMF, another Npcf_UEPolicyControl create response message that contains the URSP Data, app ID, URSP-MAC-I_{AUSF}, and Counter_{URSP}, the other Npcf_UEPolicyControl create response message to configure the UE to apply the URSP data in response to verification by the UE of a URSPAUTH-MAC-I_{AUSF} generated by the UE based on the app ID with the URSPAUTH-MAC-I_{AUSF} in the other Npcf_UEPolicyControl create response message.

18. The apparatus of claim 17, wherein the URSPAUTH-MAC-I_{AUSF} is generated using a UE-specific home key (K_{AUSF}) and the Counter_{URSP}.

19. A non-transitory computer-readable storage medium that stores instructions for execution by one or more processors of a policy control function (PCF), the one or more processors to configure the PCF to, when the instructions are executed:
determine that user equipment (UE) Route Selection Policy (URSP) parameters for a UE are to be updated while the UE is registered to a visited public land mobile network (VPLMN);
transmit, to an authentication server function (AUSF), a Nausf_URSPProtection service operation message that includes URSP Data, the URSP Data including the URSP parameters in a secured packet;
receive, from the AUSF, a URSP-MAC-I_{AUSF} and Counter_{URSP} for the UE to verify the URSP Data; and
transmit, to the UE via an access and mobility function (AMF), a Npcf_UEPolicyControl create response message that contains the URSP Data, URSP-MAC-I_{AUSF}, and Counter_{URSP}.

20. The medium of claim 19, wherein the one or more processors, when the instructions are executed, configure the PCF to:
transmit, to the AUSF, another Nausf_URSPProtection service operation message that includes an application identifier (app ID) of an application, and at least one of authentication information, token, or certificate of a genuine publisher of the application from an application function;
receive, from the AUSF in response to the other Nausf_URSPProtection service operation message, a Nausf_URSPProtection response that includes a URSPAUTH-MAC-I_{AUSF} and Counter_{URSP}; and
transmit, to the UE via the AMF, another Npcf_UEPolicyControl create response message that contains the URSP Data, app ID, URSP-MAC-I_{AUSF}, and Counter_{URSP}, the other Npcf_UEPolicyControl create response message to configure the UE to apply the URSP data in response to verification by the UE of a URSPAUTH-MAC-I_{AUSF} generated by the UE based on the app ID with the URSPAUTH-MAC-I_{AUSF} in the other Npcf_UEPolicyControl create response message.
